(19) United States
(12) Patent Application Publication
(10) Pub. No.: US 2004/0261128 A1
(43) Pub. Date: Dec. 23, 2004

(54) METHOD AND APPARATUS FOR PLACEMENT OF AUXILIARY CONTENT IN A STREAM OF INFORMATION

(75) Inventors: James Benjamin Fahy, Del Mar, CA (US); Craig D. Mautner, San Diego, CA (US); David M. Eltinge, Encinitas, CA (US)

Correspondence Address: DVA / PIONEER DIGITAL TECHNOLOGIES, SUITE 200, 2355 MAIN STREET, IRVINE, CA, 92614, US

(73) Assignee: PIONEER DIGITAL TECHNOLOGIES, INC., San Diego, CA (US)

(21) Appl. No.: 10/250,248

(22) Filed: Jun. 17, 2003

(51) Int. Cl. H04N 7/16

(52) U.S. Cl. 725/136

(57) ABSTRACT

A method and apparatus located at the end-user of a communications system that inserts auxiliary information, which is stored in a local storage, into a stream of information containing markers therein.

### BACKGROUND OF INVENTION

1. Field of the Invention

This invention relates generally to digital set-top boxes and a system which places auxiliary information in a stream of video and/or audio information.

2. Background of the Invention

In conventional television programming, programs interspersed with commercials are broadcast to a viewer. The actual programming content viewed by the user is already pre-edited before distribution to the user and thus cannot be changed once it is distributed. This traditional system is inflexible in that a program with the same set of commercials is presented to all the viewers regardless of their geographic location or interests. It may be desirable to have commercial content depend on the geographic location or even on the particular interests of the household to which the program is being sent. Furthermore, it may be desirable to eliminate the commercials completely to those willing to pay a premium price. Moreover, it may be desirable to insert auxiliary content into a program other than commercials.

### SUMMARY OF INVENTION

It is an object of the present invention to allow broadcasters control of their advertising practices by providing commercials and other auxiliary content tailored to the end-user. It is a further objective of the present invention to provide a technology which allows auxiliary content to be flexibly inserted into programs at various points along the communications path and potentially by multiple users.

In order to achieve the above-mentioned objective, the present invention provides an apparatus and method for placement of auxiliary content in a stream of digital information. According to the present invention, a local storage medium stores the plurality of auxiliary content at the location of the end-user. A control mechanism is configured to insert one of the plurality of auxiliary contents into the stream of digital information.

### BRIEF DESCRIPTION OF DRAWINGS

In order to facilitate a fuller understanding of the present invention, reference is now made to the appended drawings. These drawings should not be construed as limiting the present invention, but are intended to be exemplary only.

FIG. 1 is a functional block diagram of a cable television system according to the present invention.

FIG. 2 is a diagram that shows a set-top box according to the present invention.

FIG. 3A shows an information stream with auxiliary contents to be inserted at locations designated by markers according to the present invention.

FIG. 3B shows placement of a marker in a packet of an MPEG stream according to the present invention.

FIG. 4A shows a functional block diagram of a personal video recorder according to the present invention.

FIG. 4B show the data flow to and from the buffer memory according to the present invention.

FIG. 5A shows a stream of information with markers according to a second embodiment of the present invention.

FIG. 5B shows a stream of information with auxiliary contents inserted between the markers according to a second embodiment of the present invention.

FIG. 6 shows a stream of information with different types of auxiliary contents according to the present invention.

FIG. 7 shows a method for placement of auxiliary contents in a stream of information according to the present invention.

### DETAILED DESCRIPTION

The present invention is a method and apparatus for placement of auxiliary information in a stream of information, which includes: pre-placement, local placement, and post-placement of information in the stream of information. In pre-placement, the stream is prepared with markers and auxiliary content at the head-end which is then received by the set-top box and displayed without further alteration of the information. In local placement, the stream's content is altered at the end-user destination by an application of the set-top box which inserts auxiliary content locally stored into the stream of information, thus changing the content of the stream at the location of the end-user. In post placement, the contents of the stream is controlled remotely by the head-end but the auxiliary content is still stored in a data storage at the location of the end-user.

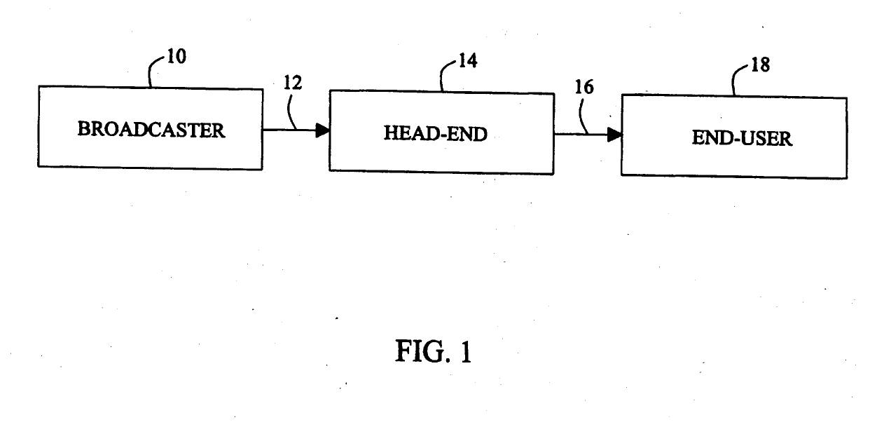

Referring to FIG. 1, there is shown a schematic diagram illustrating the flow of information for a cable television and/or audio system providing program content from a broadcaster 10, to a head-end 14, to an end-user 18. The broadcaster 10 delivers programmed channel video or audio signals over high speed telecommunications networks 12 (e.g., satellites, fiber optic cable) to one of a plurality of cable head ends 14. Although an example is given herein of a cable television and/or audio system, the apparatus and method of the present invention for placement of auxiliary content in a stream of information is also configurable for use with other communication systems, such as satellite television and/or audio systems and terrestrial television and/or audio systems.

The head-end 14 is equipped with a communications receiver, such as a satellite dish, in order to receive the analog broadcast or digital broadcast TV or audio programs over the telecommunications networks 12. The head end 14 conditions the channel signals, mixes the signals, and performs other alterations on those signals and then places the video and/or audio signals onto the cables 16 leading to the location of the end-user system 18.

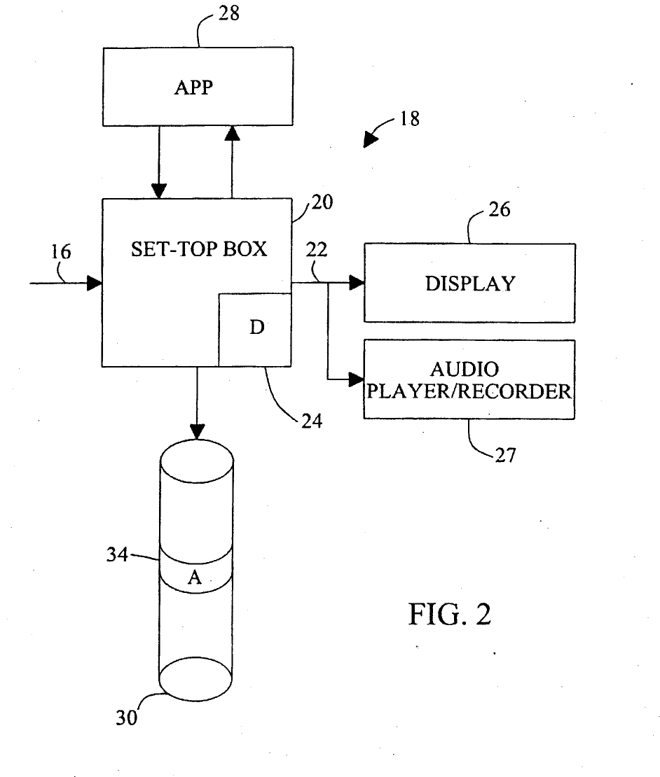

At the location of the end-user 18, there is, as shown in FIG. 2, a set-top box 20 which receives the video and/or audio programs over the communication path 16, and a video display unit 26 for viewing the video programs and/or an audio player/recorder 27 for listening to the audio programs (e.g., MP3).

Referring to FIG. 2, the set-top box 20 is any electronic device in an enclosure designed to sit on top of and be connected to a standard television receiver or audio player to provide additional channels or enhanced capabilities. The set-top box 20 receives the video and/or audio signals on the communications path 16, enhances the signals, and displays them on the video unit 26 or feeds them to the audio unit 27. The set-top box 20 connects to the video display unit 26 or the audio unit 27 via an electrical interface 22 (for example, a cable) which facilitates the use of the broadcast signals such as live television signals and video on demand broadcasts. The control mechanism 28 of the set-top box 20 is used to enhance and operate on the video content or audio content coming from the communication path 16. The control mechanism 28 contains one or more applications which operate on the stream of information 16 as further discussed herein.

Additionally, there is shown a local storage unit 30 (e.g., a hard disk) which has auxiliary information 34 stored therein. Auxiliary information 34 is referred to herein, as any content other than the regular programming which is stored of the local storage 30 and which is to be inserted into the program stream 16, for example commercials, bookmarks, and other application events. In a first embodiment, a stream of information on communications path 16 is an encoded of digital information, for example, an MPEG-2 encoded stream of information. The communications path 16 may contain an analog or digital signal. The stream is processed by the set-top box 20 and is decoded by decoder 24 and sent via cable 22 to the video display unit 26 for viewing by a user or the audio unit 27 for listening by the user. The stream of information on communications path 16 need not be limited to a stream of information containing MPEG packets, but also includes other representations of streams, such as a stream based on any proprietary or non-proprietary standard that would allow private data to be inserted into that stream content (e.g., windows media, real audio, quick-time).

Stream Prepared in Advance by Head-End

In a first embodiment, the stream of information 16 is prepared in advance by having the markers added to the program stream at the head-end 14. The markers may also be added before the head-end 14 by the broadcaster 10 or possibly earlier by the producer of the program contents. A marker identifies points within the stream where the auxiliary contents 34 may be asserted.

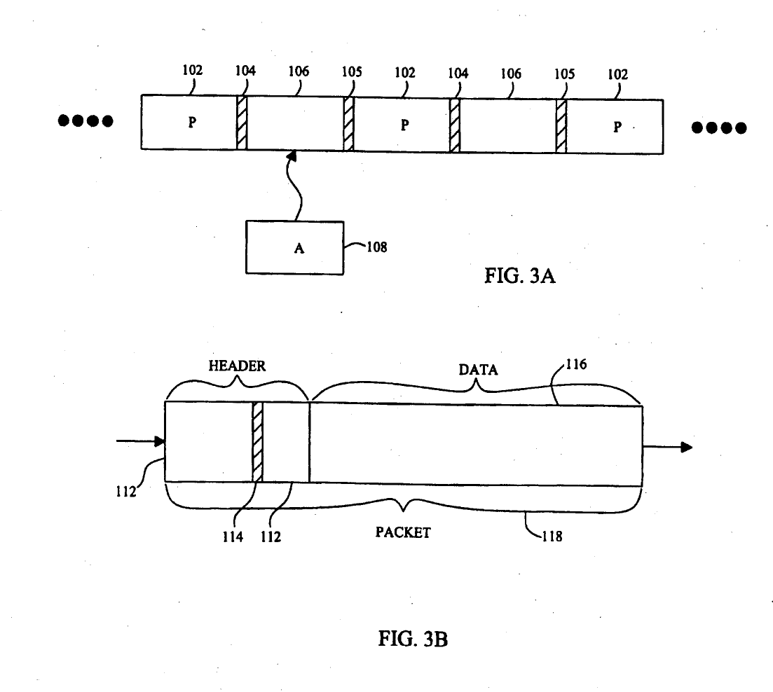

FIG. 3A shows a stream of information 16a present on the communications path 16. The stream of information 16a comprises a plurality of programs 102 or program segments with start markers 104, and stop markers 105 interspersed at various locations of the stream of information 16a. The start markers 104 denotes the beginning of spaces 106 and the stop markers 105 denotes the end of spaces 106 where the spaces 106 do not have any program content. The control mechanism 28 inserts an auxiliary content 108 from the auxiliary content 34 stored on local storage 30 into one of the spaces 106. Thus, by this method, the viewer of video display unit 26 or listener of the audio unit 27 is presented with programming content along with the auxiliary contents 34. Thus, by this apparatus and method, a user is presented with auxiliary content 34 tailored to the user's situation. For example, if the viewer is a sports fan, the auxiliary content 34 could be commercials that are directed only to sports fans. Or the auxiliary content 34 could be commercials that only advertise businesses local the user's area.

FIG. 3B shows in one embodiment an MPEG stream of information appearing on the communications path 16. The MPEG stream is divided into a plurality of packets 118 wherein each packet 118 comprises a header 112 and data 116. In an embodiment of the present invention, a marker 114 is placed in the stream of packets 118 by the head-end or broadcaster. The control mechanism 28 (alternately referred to as an application) is configured to detect the markers 114, retrieve the appropriate auxiliary content 34 from the local storage unit 30, and place the auxiliary content 34 into the data stream at space 106. By this method the markers 104, 105 are encoded in the stream of information 16a.

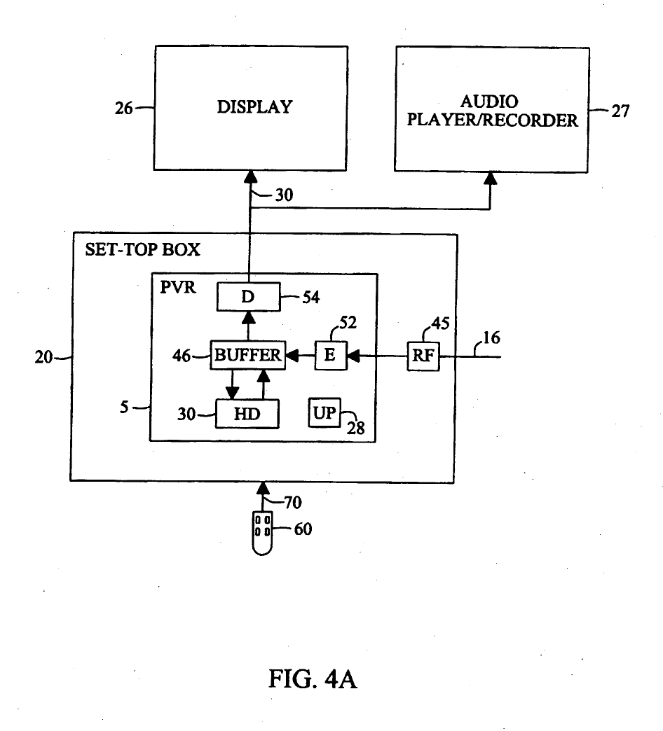

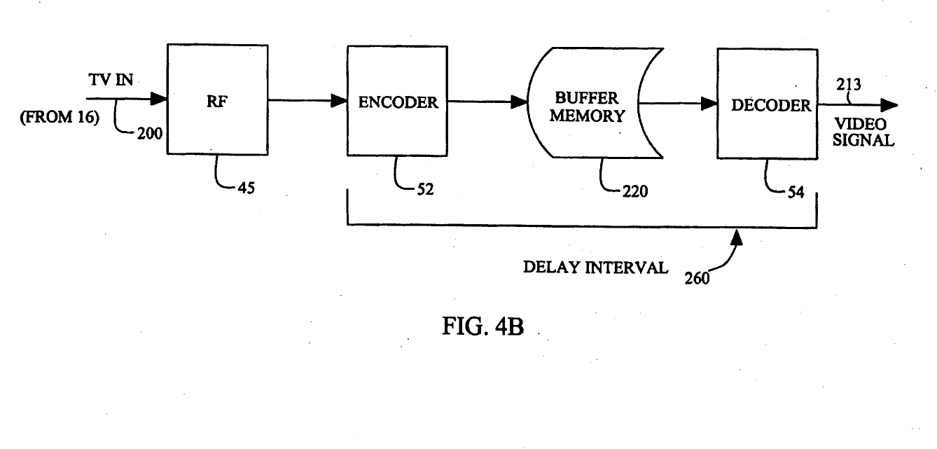

FIG. 4A shows a second embodiment of the present invention which is a combination of a digital set-top box 20 and a personal video recorder 5. The personal video recorder 5 (PVR) lets the viewer view television programs in a time shifted mode so that the viewer can digitally record programs and apply VCR-like functionality to TV programming. For example, the PVR lets the viewer pause, replay, fast-forward, or skip over advertising while viewing a live TV program. Alternately, the set-top box 20 can be connected to an audio player/recorder 27.

Referring to FIG. 4A, the set-top box 20 which couples various broadcast signals 200 (FIG. 4B) via the communications path 16 to the video display unit 26 or audio unit 27 contains functionality which enables the presentation of video or audio programming from the broadcast signals 200. The set-top box 20 connects to the video display unit 26 or the audio unit 27 via an electrical interface 30 (for example, a cable) which facilitates the use of the broadcast signals 200 such as live television signals and video on demand broadcasts.

Set-top box 20 receives user input entered from the handheld remote control 60 over the wireless link 70. The wireless link 70 may be an infrared link, a radio frequency link, or any other suitable type of link.

The software or firmware that controls the set-top box 20 may be installed locally or it may be downloaded from the Internet as needed or it may be downloaded over the same communications path 16 providing video or audio input when configuring new set-top boxes or when updating existing ones.

Referring again to FIG. 4A, the PVR 5 can be an external component or, alternately, a component internal to the set-top box 20. The PVR 5 includes some or all of a combination of software, hardware, and firmware. In one embodiment, the PVR 5 uses a memory storage device 30 (e.g., a disk drive) that is internal to the set-top box 20 where broadcasts are recorded. The broadcast signals 200 (such as live television signals, video on demand broadcasts, audio broadcasts, see FIG. 4B) are received by the set-top box 20 via communication path 16, which may be connected to either an antenna or a cable television outlet.

One or more tuner systems 45 are configured to allow the system to receive broadcast signals 200 over communication path 16 from the multiple channels. The tuner system 45 works in conjunction with the random access semiconductor memory 46 so that for each tuner in the system, each can simultaneously record or display channels up to the given number of tuners. The video or audio signal 200 at path 16 is received by the tuner 45 which demodulates the video signal resulting in a base band digital stream. The tuner 45 may also embody other functions which prepare the video or audio stream for storage, such as an analog-to-digital converter to convert an analog video or audio signal to a digital form. The encoder 52 compresses the digital stream according to a video or audio standard. For example, limited storage capacity is used efficiently by compressing the digital stream using an algorithm, typically one of the MPEG (Moving Pictures Experts Group) standard algorithms, which can achieve a useful compression of 100:1 in many cases. The compressed digital information of the video stream is then stored initially in the random access semiconductor memory 46 and then possibly transferred to the permanent storage 30, for example a hard disk or optical disk. To prepare the contents for viewing, the digital information in the memory 46 is sent to the decoder and decompressed via the decompress or 54. The decompressed digital information is then sent via the communication path 30 to be viewed on the video display unit 26 or directed to the audio unit 27. The control mechanism 28 operates under program control to form commands that operate on the data of the buffer memory 220 as described below.

FIG. 4B shows the data flow starting from reception of the broadcast signal 16, processing and storing the broadcast signal, and ending with display of a program of the broadcast signal on the video display unit 26 or audio unit 27. As mentioned above, the broadcast signal 200 is converted to digital information by tuner 45 (e.g., demodulation) and then compressed by encoder 52 to digital information suitable for storage in the buffer memory 220. The buffer memory 220 comprises some combination of the semiconductor memory 46 and a portion of the local storage unit 30. Typically, the buffer memory 220 comprises the entire local storage unit 30. After the digital information leaves buffer memory 220, the digital information is decoded by decoder 54 and the outgoing video or audio signal 213 is presented on the video display unit 26 or the audio unit 27. It should be noted that a delay interval 260 of a given (x) number of seconds occurs between the time the signal reaches encoder 52 and is output by decoder 54. Therefore, a live TV or audio signal is typically a signal that has been delayed by (x) seconds. If a user is watching a program and is currently recording the program as well, the buffer memory 220 is not used for decoding until the program is paused or rewound.

Placement of Auxiliary in Formation by Set-Top Box

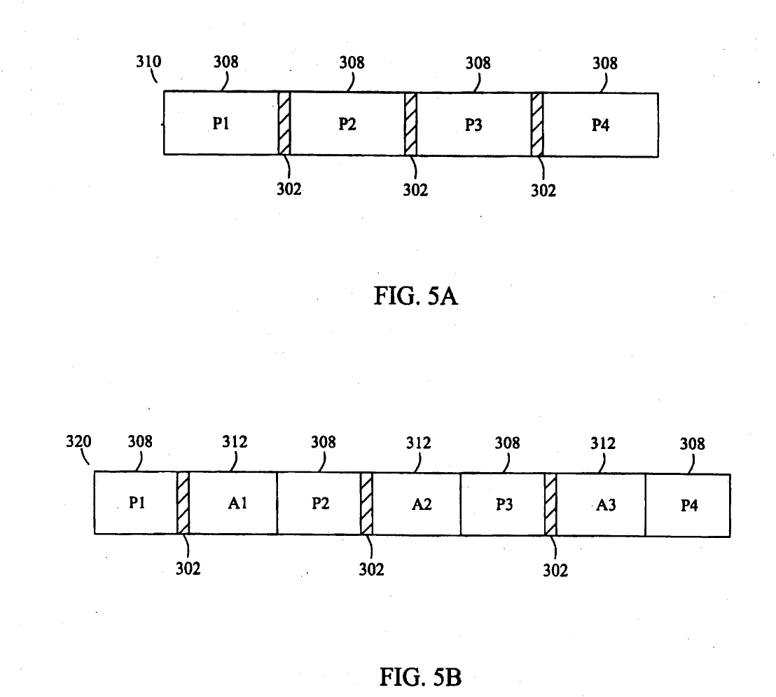

FIG. 5A shows a stream of information 310 as presented on the communications path 16. The stream of information 310 comprises programs or segments of programs 308, for example P1-P4, with markers 302 inserted therein. The control mechanism 28 inserts auxiliary contents 312, for example A1-A4, at the markers 302 to form the stream 320 shown in FIG. 5B. In this embodiment, the stream of information 310 is stored in the temporary buffer 220 to allow display of the auxiliary content A1-A4. The markers are detectable by the process described above associated with FIG. 3B.

Stream Marked by User

In this embodiment, the user through control mechanism 28 can place marks in the stream of information. For example, the user may wish to insert a bookmark at a location of the program to identify a location that the user wishes to return to later. Or the user may wish to insert a link to a web page at a location of the program. Other types of auxiliary content may also be inserted by the user into the stream of information. An object such as a bookmark, webpage, or other user-defined object may be part of the auxiliary content 34.

Head-End Changes Auxiliary Content on Local Hard Disk

In this embodiment, the head-end 14 has control of the contents of the local storage 30. The head-end 14 may download auxiliary content 34 to the hard disk 30, and, additionally, replace, delete, or modify content. The following services can be provided by the head end 14.

In a deletion operation, the broadcaster deletes all commercials from a particular program for a price. This is done before or after the program is recorded.

In a subtraction operation, the number of commercials is reduced, but not totally deleted. For example, a commercial may be reduced from 3 minutes to 1 minute. That is, the commercial is of a predetermined length associated with a user subscription. The user is charged more for the subscription for a commercial of shorter length.

In an addition operation, the commercials are shortened for additional revenue.

In a replacement operation, broadcasts are tailored to a specific audience and household. If the commercials are of interest to the consumer, the consumer may want to watch to commercials instead of deleting them. Thus, the commercial of one of the auxiliary contents is substituted for a commercial already present in the stream of information.

In an insertion operation, commercials are inserted at particular points in the stream of information.

Stream Controlled by Multiple Sources

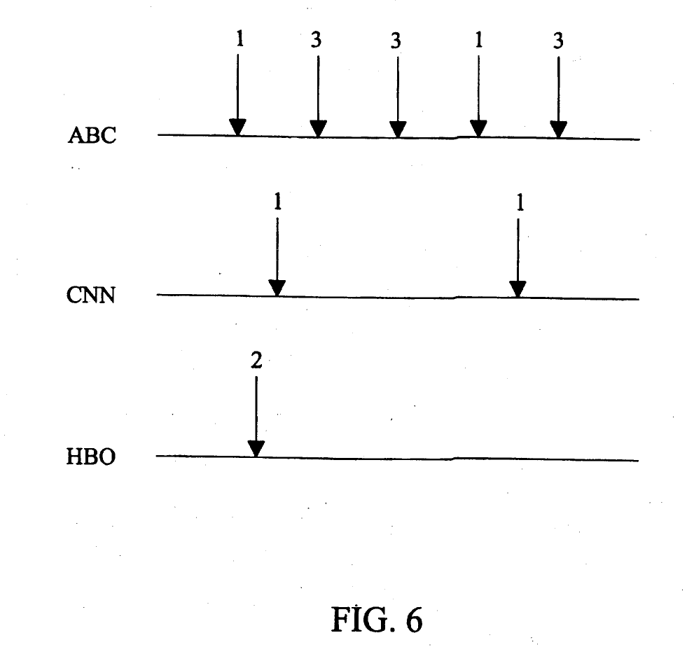

FIG. 6 shows an embodiment of a programming stream being controlled by more than one source of control. An advantage of the present invention is that multiple sources may control the placement of auxiliary content within the data stream. For example, the broadcaster may control placement of data and charge the user for shorter use of commercials or charge the user a premium price to completely eliminate commercials. Additionally, the head-end may control the placement of commercials to tailor them to the local area. In one scheme, commercials having different lengths would be prepared by the broadcaster in advance and the user would subscribe to a subscription plan selecting a particular commercial length and price associated with that commercial length. The user may place auxiliary content useful to the user, such as bookmarks or references to web pages.

Table 1 shows an example of a set of identifiers and their associated actions. Table 1 is not meant to be an exclusive set of actions. The identifier field assigns a number associated with an action to be executed by an application of the control mechanism 28. For example, The action for identifier 1 inserts a commercial designated as #x into the stream of information. The action for identifier 2 deletes a commercial. The action for identifier 3 activates a specific web page. The action for identifier 4 inserts a user created auxiliary content into the steam of information. The action for identifier 5 displays a web page logo in the stream of information.

TABLE 1

| IDENTIFIER | ACTION |
|---|---|
| 1. | insert commercial #s in PER file |
| 2. | delete commercial |
| 3. | pop up web page www.pioneer.com |
| 4. | insert user defined contents |
| 5. | display web page www.sony.com |

One application of the auxiliary data according to the present invention is for copyright and security protection. A copyright marker is added to content (e.g., audio, video, data) that pops up a copyright notice upon playback, or makes it so that content does not play at all. The copyright marker is removed by the head-end or locally for a price. A security marker is used to mark content to be played on a particular device. The device may be added for a fee.

Table 2 shows one example of a layout showing the actions that will be performed in a program. There will be a stamp ID to uniquely identify each marker with an associated action and owner. Table 2 shows an example of a table with four identified stamps. In general there will be an arbitrary number of stamp IDs, for example, N stamp IDs would be necessary to specify N actions in a stream of information.

TABLE 2

| STAMP ID | CONTROL OR OWNER | ACTION ID |
|---|---|---|
| 1 | cable operator | 1 |
| 2 | user | 2 |
| 3 | cable but user commercial overwritten | 3 |
| 4 | user | 2 |
| 5 | cable operator | 1 |

FIG. 6 is an example of one possible configuration of streams. The ABC stream has auxiliary content inserted throughout the stream by various users end each auxiliary content having an action associated therewith., First, a cable operator inserts a commercial (action 1). Then at the next two locations web browsers pop up (action 3). Then there is another commercial inserted by the cable operator (action 1) followed by a pop up browser (action 3). The CNN stream has two commercials inserted by the cable operator (action 2). The HBO stream has a user commercial substituted for a previous cable commercial (action 2). Thus, in this configuration, a stream of information comprises one or more types of actions inserted into the stream of information by one or more user sources.

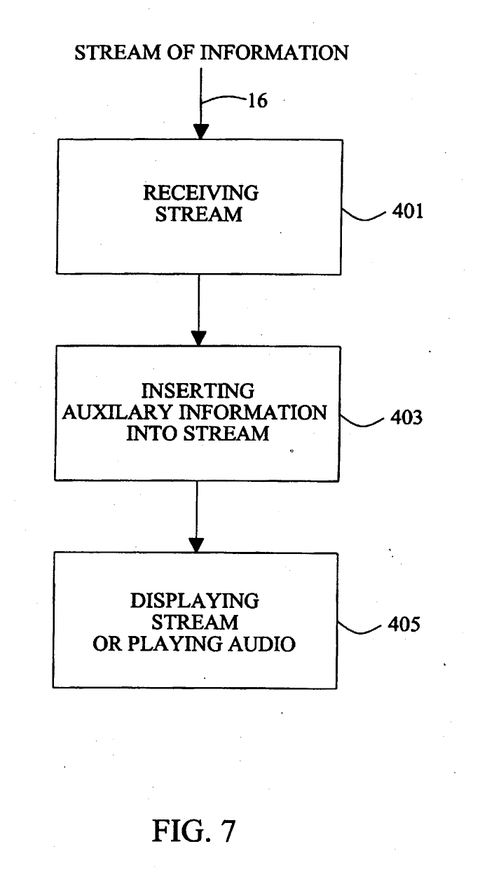

FIG. 7 shows the general method for placement of auxiliary content in a stream of information. In step 401, the stream of information 16 is received at the end-user 18 at the set-top box 20. At step 403, auxiliary information 34 located in the local storage 30 is inserted into the stream of information. In step 405, the stream of information with the auxiliary information is displayed on the display 26 or alternately played on the audio unit 27.

The present invention is not to be limited in scope by the specific embodiments described herein. Indeed, this application is intended to cover any modifications of the present invention, in addition to those described herein, and the present invention is not confined to the details which have been set forth. For example, the stream of information need not be limited to a stream of information containing MPEG packets, but also includes other representations of streams, such as a stream based on any proprietary or non-proprietary standard that would allow private data to be inserted into that stream content (e.g., windows media, real audio, quick-time). Thus, the scope of the invention should be determined by the appended claims and their legal equivalents, rather than by the examples given.

1. An apparatus for placement of a plurality of auxiliary contents in a stream of information containing markers therein, comprising: a local storage configured to store said plurality of auxiliary contents; and a control mechanism configured to insert one of said plurality of auxiliary contents into said stream of information as determined by one of said markers.

2. The apparatus of claim 1, further comprising a buffer mechanism configured to store said stream of information.

3. The apparatus of claim 1, further comprising a display configured to display said stream of information comprising said auxiliary contents.

4. The apparatus of claim 1, further comprising an audio player configured to play said stream of information comprising said auxiliary contents.

5. The apparatus of claim 1 comprises a personal video recorder.

6. The apparatus of claim 1 comprises an audio player.

7. The apparatus of claim 1 comprises a set-top box.

8. The apparatus of claim 1, wherein said stream of information comprises one or more programs selected from the group consisting of audio programs or video programs.

9. The apparatus of claim 1, wherein said control mechanism is activated by an application local to said local storage.

10. The apparatus of claim 1, wherein said control mechanism is activated by a user.

11. The apparatus of claim 1, further comprising: a head-end, wherein said control mechanism is remotely activated by said head-end to alter said auxiliary contents on said local storage.

12. The apparatus of claim 1, further comprising: a head-end, wherein said auxiliary contents is downloaded to said local storage by said head-end.

13. The apparatus of claim 1, wherein at least one of said plurality of auxiliary contents comprises a commercial.

14. The apparatus of claim 13, wherein said commercial is of a predetermined length associated with a user subscription, wherein the user is charged more for said subscription for a commercial of shorter length.

15. The apparatus of claim 13, wherein said commercial of one of said auxiliary contents is substituted for a commercial already present in said stream of information.

16. The apparatus of claim 1, wherein at least one of said plurality of auxiliary contents comprises a user-defined object selected from the group comprising a bookmark and a web page.

17. The apparatus of claim 1, wherein said control mechanism analyzes one or more MPEG packets contained within said stream of information to detect said markers.

18. The apparatus of claim 1, wherein said auxiliary contents have associated therewith one or more actions and one or more owners and said auxiliary contents is inserted into said stream of digital information according to said actions and by said owners.

19. The apparatus of claim 1, wherein said auxiliary contents comprises a copyright marker.

20. The apparatus of claim 1, wherein said auxiliary contents comprises a security marker.

21. A method for placement of auxiliary information in a information signal, comprising the steps of: receiving locally said information signal containing one or more programs containing markers therein; and inserting said auxiliary information into said information signal, wherein said auxiliary information has been stored locally, at positions denoted by said markers.

22. The method of claim 21 wherein said information signal comprises a video signal.

23. The method of claim 21 wherein said information signal comprises an audio signal.

24. The method of claim 21, further comprising the step of displaying said information signal and said auxiliary information.

25. The method of claim 21, further comprising the step of playing said information signal and said auxiliary information.

26. The method of claim 21, wherein in the step of receiving, said video signal is received by a personal video recorder of an end-user.

27. The method of claim 21, further comprising the step of inserting said markers into said information signal by a user.

28. The method of claim 21, further comprising the step of inserting said markers in said information signal at a head-end.

29. The method of claim 21, further comprising a head end; and further comprising the step of modifying by said head-end the auxiliary information stored locally.

30. The method of claim 21, further comprising the step of inserting said markers in said information signal before said information signal is transmitted to a local user.

31. The method of claim 21, further comprising analyzing MPEG packets of said information signal to detect said markers.

32. An apparatus, comprising: a source for providing a plurality of auxiliary contents; a local storage configured to store said plurality of auxiliary contents when received from said source; and a control mechanism configured to insert at least one of said plurality of auxiliary contents into a stream of information as determined by one of a plurality of markers therein.

33. The apparatus of claim 32, further comprising a buffer mechanism configured to store said stream of information.

34. The apparatus of claim 32, further comprising a display configured to display said stream of information comprising said auxiliary contents.

35. The apparatus of claim 32, further comprising an audio player configured to play said stream of information comprising said auxiliary contents.

36. The apparatus of claim 32, wherein at least one of said plurality of auxiliary contents comprises a commercial.

37. The apparatus of claim 36, wherein said commercial is of a predetermined length associated with a user subscription, wherein the user is charged more for said subscription for a commercial of shorter length.

38. The apparatus of claim 36, wherein said commercial of one of said auxiliary contents is substituted for a commercial already present in said stream of information.

39. The apparatus of claim 32, wherein said auxiliary contents have associated therewith one or more actions and one or more owners and said auxiliary contents is inserted into said stream of digital information according to said actions and by said owners.

40. The apparatus of claim 32, wherein said auxiliary contents comprises a copyright marker.

41. The apparatus of claim 32, wherein said auxiliary contents comprises a security marker.
